(19) United States
(12) Patent Application Publication
(10) Pub. No.: US 2003/0188024 A1
(43) Pub. Date: Oct. 2, 2003

(54) Method and system for a cloaking service for use with a distributed virtual enterprise

(75) Inventors: Margaret G. MacPhail, Corpus Christi, TX (US); David B. Kumhyr, Austin, TX (US); Sebastian D. Hassinger, Yorktown Heights, NY (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, Armonk, NY

(21) Appl. No.: 10/112,530

(22) Filed: Mar. 28, 2002

(51) Int. Cl. G06F 17/60

(52) U.S. Cl. 709/246; 705/1

(57) ABSTRACT

A cloaking service participates in an electronic marketplace to process documents associated with electronic business transactions. Different types of marketplace participants or business entities within the electronic marketplace can use the cloaking service to hide information about their electronic business transactions for a variety of reasons: to maintain the confidentiality of proprietary data; to hide the origination of a business transaction or the identity of participants to a business transaction; or to minimize the visibility of various aspects of their business transactions, including the quantity of business transactions. Entities register cloaking preferences with the cloaking service, and rather than sending documents directly into the electronic marketplace, a business entity sends its documents to the cloaking service, which then modifies the documents in accordance with the previously registered set of cloaking preferences prior to forwarding the modified documents.

### CROSS-REFERENCE TO RELATED APPLICATIONS

The present application is related to the following applications, which are hereby incorporated by reference:

Application Ser. No. ______ (Attorney Docket Number AUS920010200US1), filed (TBD), titled “Method and system for distributed virtual enterprise dependency objects”;

Application Ser. No. ______ (Attorney Docket Number AUS920010204US1), filed (TBD), titled “Method and system for distributed virtual enterprise project model processing”;

Application Ser. No. ______ (Attorney Docket Number AUS920010633US1), filed (TBD), titled “Method and system for manipulation of scheduling information in a distributed virtual enterprise”; and

Application Ser. No. ______ (Attorney Docket Number AUS920010634US1), filed (TBD), titled “Method and system for manipulation of cost information in a distributed virtual enterprise”.

### BACKGROUND OF THE INVENTION

1. Field of the Invention

The present invention relates to an improved data processing system and, in particular, to an automated electronic business practice. Still more particularly, the present invention is directed to an automated service within a marketplace for electronic commerce.

2. Description of Related Art

In recent years, a variety of electronic trading exchanges or electronic marketplaces have been developed that allow businesses to conduct transactions across the Internet. In general, these electronic marketplaces comprise a collection of separate business entities that voluntarily interface their private computer systems with the systems of other business entities in the pursuit of some collective purpose or service. In other words, buyers and sellers of goods and services organize themselves into a digital marketplace for cooperative exchange of goods and services. In fact, these services may include not only “real-world” services but also purely electronic or digital services. These electronic exchanges represent a neutral, centralized, beneficial, computer-mediated, marketplace in which competitors can conduct a limited portion of their business activities.

While some businesses offer proprietary middleware for facilitating the integration of existing legacy computer systems with these relatively new electronic marketplaces, there have been some initiatives towards reducing the complexity of these interfaces in order to reduce the cost of interacting with these electronic exchanges, thereby increasing the number of business organizations that might desire to participate in the exchanges. For example, the ebXML (electronic business extensible markup language) set of specifications has been developed for creating an electronic business infrastructure that is based on the exchange of XML-structured data. The widespread adoption of standardized protocols should allow business entities to interface with electronic exchanges with minimal cost and complexity.

While the adoption of standards may simplify the transactions between business entities, it should be expected that these business entities will support multiple electronic exchanges for various competitive reasons as they seek advantages over other business entities. From one perspective, an electronic marketplace introduces an aspect of transparency or openness to otherwise opaque or secretive business transactions. However, it should be expected that business entities will desire to maintain some level of opaqueness or confidentiality in their business transactions.

In other words, the convergence of Internet-based electronic exchanges, application service providers, and e-businesses is leading to an increasingly dynamic landscape for conducting business. In a global economy in which capital and resources are increasingly available to business entities around the world, information becomes an increasingly valuable resource. Hence, at the same time that business entities are interconnecting through these newly developed electronic exchanges in a web of electronic commerce, business entities also need to protect proprietary information.

Therefore, it would be advantageous to provide new methodologies for protecting proprietary data within this e-business landscape. In particular, it would be advantageous to provide a technique for enabling a business entity to participate in an electronic marketplace or electronic exchange while allowing the business entity to protect its proprietary data.

### SUMMARY OF THE INVENTION

The convergence of Internet-based electronic exchanges, application service providers, and e-businesses enables the existence of a distributed virtual enterprise (DVE) in which a business entity has little or no physical assets and whose only e-commerce role is the ability to link various customers and suppliers in a proprietary mesh of business transactions. Even though electronic exchanges significantly reduce transaction costs and significantly increase the ability of business entities to gather competitive information, a virtual enterprise could still generate profits as an intermediate entity within these new electronic exchanges by protecting and employing institutional knowledge.

A cloaking service participates in an electronic marketplace to process documents associated with electronic business transactions. Different types of marketplace participants or business entities within the electronic marketplace can use the cloaking service to hide information about their electronic business transactions for a variety of reasons: to maintain the confidentiality of proprietary data; to hide the origination of a business transaction or the identity of participants to a business transaction; or to minimize the visibility of various aspects of their business transactions, including the quantity of business transactions. Entities register cloaking preferences with the cloaking service, and rather than sending documents directly into the electronic marketplace, a business entity sends its documents to the cloaking service, which then modifies the documents in accordance with the previously registered set of cloaking preferences prior to forwarding the modified documents.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 is a block diagram that depicts data flow operations between commercial entities via a cloaking service;

FIG. 3 is a block diagram that depicts the use of a cloaking service between trading partners in conjunction with an ebXML-compliant electronic marketplace;

FIG. 4 is a block diagram that depicts a set of commercial entities and data elements that are used to describe a typical electronic business collaboration in accordance with processes and events that are defined within the ebXML (electronic business extensible Markup Language) set of specifications;

FIG. 5 is a block diagram that depicts a cloaking service in relation to the ebXML business service interfaces of its customers;

FIG. 6 is a block diagram that depicts a set of commercial entities and data elements for an ebXML electronic business collaboration in addition to a cloaking service;

FIG. 7 is a block diagram that depicts a wide variety of software applications that may be used with the cloaking service of the present invention in order to show that the cloaking service is not limited to regarding an enterprise as a monolithic entity;

FIG. 8A is a block diagram that depicts a typical use of an e-commerce marketplace registry;

FIGS. 8B-8E are block diagrams that depict generalized data flows between one or more suppliers and one or more buyers within which a cloaking service is used;

FIG. 9 is a block diagram that depicts an e-commerce message that has been modified by a cloaking service;

FIG. 10A is a block diagram that depicts the use of a facade class for passing data objects between a cloaking service and its customer entities, i.e., trading partners that are participating in an electronic marketplace;

FIG. 10B is a flowchart that depicts a process of accepting data at a cloaking service; and

FIG. 10C is a flowchart that depicts a process of providing e-commerce information from a cloaking service.

### DETAILED DESCRIPTION OF THE INVENTION

The present invention is a set of methodologies and techniques to be used in conjunction with one or more electronic marketplaces that may operate on a variety of data processing systems via a variety of networks. As background, a typical organization of hardware and software components within a distributed data processing system is described prior to describing the present invention in more detail.

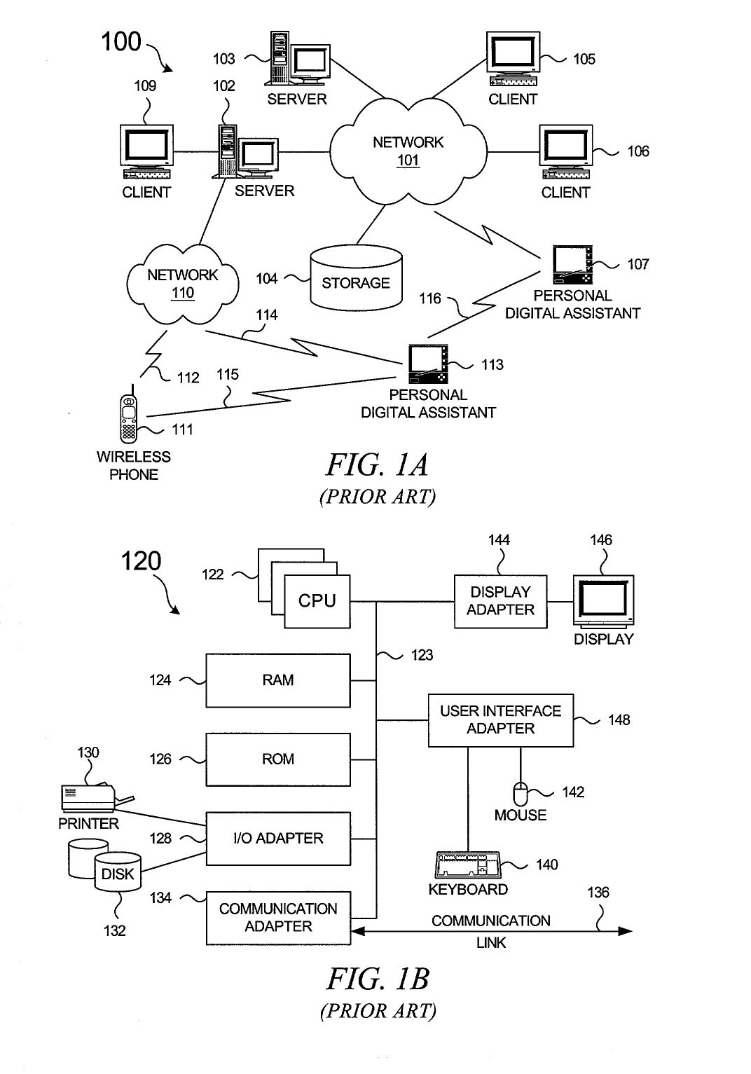

With reference now to the figures, FIG. 1A depicts a typical network of data processing systems, each of which may implement some aspect of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown. It should be noted that the distributed data processing system shown in FIG. 1A is contemplated as being fully able to support a variety of peer-to-peer subnets and peer-to-peer services.

In the depicted example, distributed data processing system 100 may include the Internet with network 101 representing a global collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), a wireless LAN, or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140, mouse 142, or other devices not shown, such as a touch screen, stylus, or microphone. Display adapter 144 connects system bus 123 to display 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Linux® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above. More specifically, though, the present invention is directed to a set of novel techniques to be used in conjunction with electronic marketplaces as will be described with respect to the remaining figures.

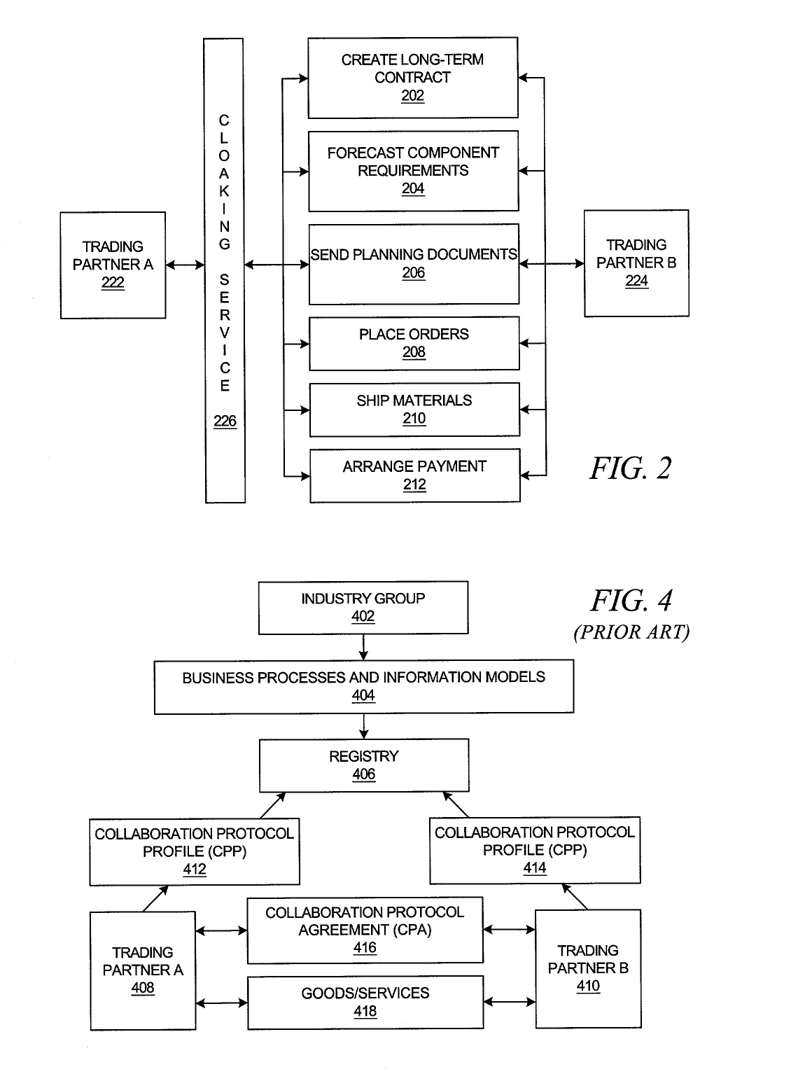

With reference to FIG. 2, a block diagram depicts data flow operations between commercial entities via a cloaking service in accordance with the present invention. Commercial transactions occur over a period of time, and each commercial transaction typically includes a set of actions by each party to the commercial transaction. These actions are typically recorded in a series of documents as evidence of the terms of agreement for completing the commercial transaction. During various phases of a commercial transaction, these documents are exchanged along with the corresponding goods, services, and financial transactions that comprise the commercial transaction.

FIG. 2 depicts a partial list of the documents, other data, and possibly material goods that may flow between commercial entities during various phases of multiple commercial transactions. For example, a long-term contract (step 202) is created, thereby allowing the parties to a set of future commercial transactions to forecast their component requirements (step 204) for completing the set of commercial transactions and those operations that are dependent upon the completion of the set of commercial transactions. After agreeing to the overall terms of the set of commercial transactions, the commercial entities can also exchange planning documents (step 206) that describe the logistics for the actual exchange, deliver, or receipt of goods and/or services.

Each exchange or delivery within the set of commercial transactions may then be associated with a purchase order (step 208) that initiates a particular commercial transaction, which includes an order and a shipment of materials (step 210) in this example. After the receipt of the materials, then a financial transaction occurs as payment (step 212) for the particular transaction. Multiple transactions may subsequently occur in accordance with the previously negotiated long-term contract.

FIG. 2 shows trading partner 222 and trading partner 224 that cooperate with each other to complete one or more commercial transactions in accordance with the typical data and material flow described above with respect to steps 202-212. In contrast to the free flow of data between typical trading partners, trading partner 222 uses cloaking service 226 as an intermediary agent for hiding and/or revealing specific details about the commercial transactions of trading partner 222, as will be described in more detail further below.

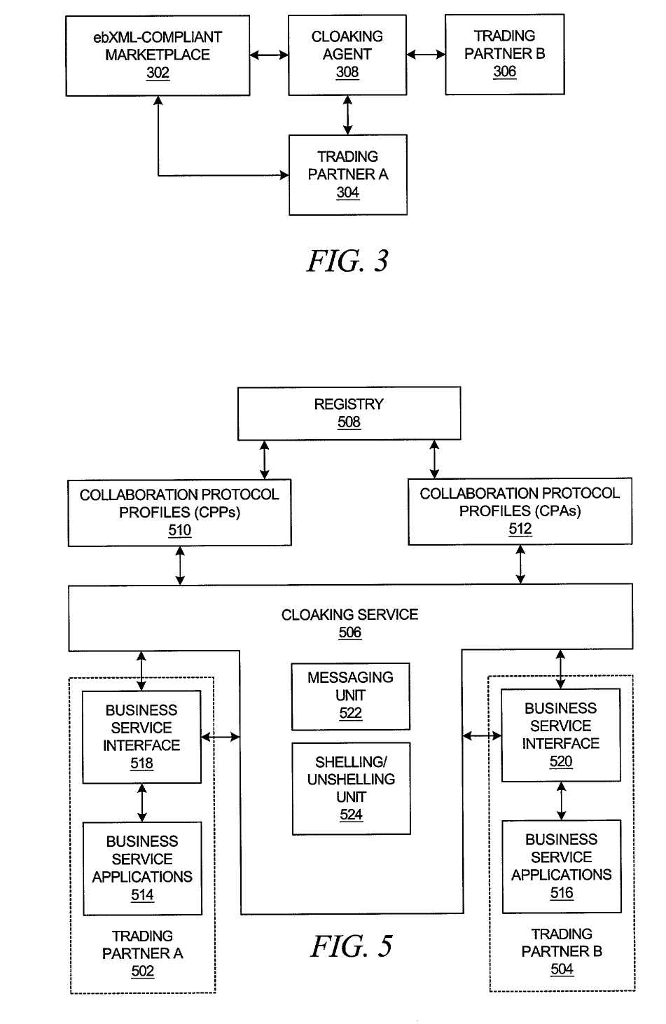

With reference now to FIG. 3, a block diagram depicts the use of a cloaking service between trading partners in conjunction with an ebXML-compliant electronic marketplace. A plurality of electronic marketplaces have been developed that use the Internet and World Wide Web to facilitate e-commerce among commercial entities; the cloaking service of the present invention can be employed in business collaborations in conjunction with a variety of predefined processes and models, such as those that are present in variety of electronic marketplaces in addition to ebXML-compliant marketplaces.

As shown in FIG. 3, in a preferred embodiment, the cloaking service is implemented in accordance with a suite of specifications that are promulgated by UN/CEFACT (United Nations Center for Trade Facilitation and Electronic Business) and the OASIS (Organization for the Advancement of Structured Information Standards) consortium such that the cloaking service is available for use by a commercial entity that accomplishes some or all of its commercial transactions using ebXML-compliant processes and data interchange. For example, ebXML-compliant marketplace 302 is open to commercial entities, such as trading partners 304 and 306, for electronic collaboration processes. However, trading partner 306 employs cloaking agent 308 as an intermediary agent for its electronic collaborations with trading partner 304 or, more generally, for ebXML-compliant marketplace 302. More information about ebXML can be found in the following documents which are hereby incorporated by reference: ebXML Technical Architecture Specification v.1.04, February, 2001; Business Process and Business Information Analysis Overview 1.0, May 2001. Although the following examples of electronic commerce activities are shown with respect to an ebXML-compliant marketplace, it should be noted that the present invention is able to be implemented with respect to specifications for a variety of electronic marketplaces/exchanges.

As noted previously, a major advantage of the recent development of Web-enabled electronic marketplaces is the ability to facilitate information exchange among trading partners. By using standard communication protocols, standards for structured information, such as XML, and standards for the exchange of commercial information, such as ebXML, these electronic marketplaces enable commercial entities to find other commercial entities which desire to engage in mutually beneficial commerce. A major disadvantage of these electronic marketplaces, however, is the ability of a commercial entity to gather information about its competitors by watching various aspects of operations within the electronic marketplace, such as the advertisement of various goods and services, the available dates and amounts of those goods and services, the purchase prices of the goods and services, and similar aspects. While information about any one commercial transaction within an electronic marketplace may not be significant, important trends and patterns may be discernible such that significant commercial intelligence may be gathered over a period of time. A competitor could use this type of commercial intelligence to its advantage in negotiating quantity discounts, price breaks, faster response times, etc., with potential trading partners.

To prevent potential competitors from gaining an advantage by gathering information about its activities in an otherwise open marketplace, a commercial entity may employ a cloaking agent/service that “cloaks” the transactions of the commercial entity. The cloaking agent hides and/or reveals certain aspects of transactions within an electronic marketplace on behalf of its customers. Referring again to FIG. 3, trading partner 306 may use cloaking agent 308 for a variety of reasons and purposes, but primarily, trading partner 306 hides its identity from other trading partners within the open marketplace; trading partner 304 is only aware that it is receiving information from cloaking agent 308, either directly or indirectly through an ebXML registry, which is explained in more detail further below. In this manner, trading partner 306 is able to make and receive contractual offers with a desired amount of anonymity such that competitors, buyers, suppliers, etc., are not able to gather information about the activities of trading partner 306.

With reference now to FIG. 4, a block diagram depicts a set of commercial entities and data elements that are used to describe a typical electronic business collaboration in accordance with processes and events that are defined within the ebXML (electronic business extensible Markup Language) set of specifications. Industry group 402 defines a set of business processes and information models 404 that can be used to describe, to structure, and to conduct commercial transactions in an industry-specific manner. These processes and models are then stored in registry 406 for the benefit of any commercial entity that desires to conduct an electronic business collaboration with another commercial entity using the defined processes and models. Alternatively, the business processes and information models may be controlled within an electronic business library that contains a catalog of these types of business documents such that the registry is directed more towards runtime activities.

Trading partners 408 and 410 represent a pair of commercial entities that use registry 406 in an electronic collaboration. Each trading partner generates a collaboration protocol profile (CPP), e.g., CPP 412 or CPP 414, that is stored in registry 406. Commercial entities can peruse the CPPs from other commercial entities to determine whether or not to enter into an electronic collaboration.

The activities related to defining and registering the business processes, the information models, and the CPPs may be considered to be “design time” activities that support “run time” activities of actual electronic collaborative activities. When two commercial entities decide to become trading partners, they exchange a collaboration protocol agreement (CPA), e.g., CPA 416, that defines the terms to which the parties have agreed for a particular collaborative activity. In this example, the trading partners may exchange goods and/or services 418 during their collaborative activity.

With reference now to FIG. 5, a block diagram depicts a cloaking service in relation to the ebXML business service interfaces of its customers. As briefly discussed above, a cloaking service can be used by a commercial entity as an intermediary agent for the data flow between the commercial entity and its trading partners. In the example shown in FIG. 5, both trading partner 502 and trading partner 504 have contracted with cloaking service 506 to act as an intermediate cloaking agent for commercial activities, although in an alternative embodiment, either of the trading partners could be customers of the cloaking service independently of the other trading partner. Cloaking service 506 accesses ebXML registry 508 on behalf of its customers, including the registration of CPPs 510 and CPPs 512.

Each trading partner has various business service applications, e.g., business service applications 514 for trading partner 502 or business service applications 516 for trading partner 504, that it uses in its ordinary course of business, such as an enterprise resource planning application. Each trading partner implements a business service interface, e.g., business service interface 518 for trading partner 502 or business service interface 520 for trading partner 504, for performing ebXML-compliant operations with other ebXML-enabled entities, such as cloaking service 506.

Cloaking service 506 has messaging unit 522 for exchanging messages between the cloaking service's customers and other ebXML-enabled entities. In addition, cloaking service 506 has shelling/unshelling unit 524 for processing messages and/or business documents from/to its customers as necessary to accomplish the cloaking operations that are desired by a particular customer.

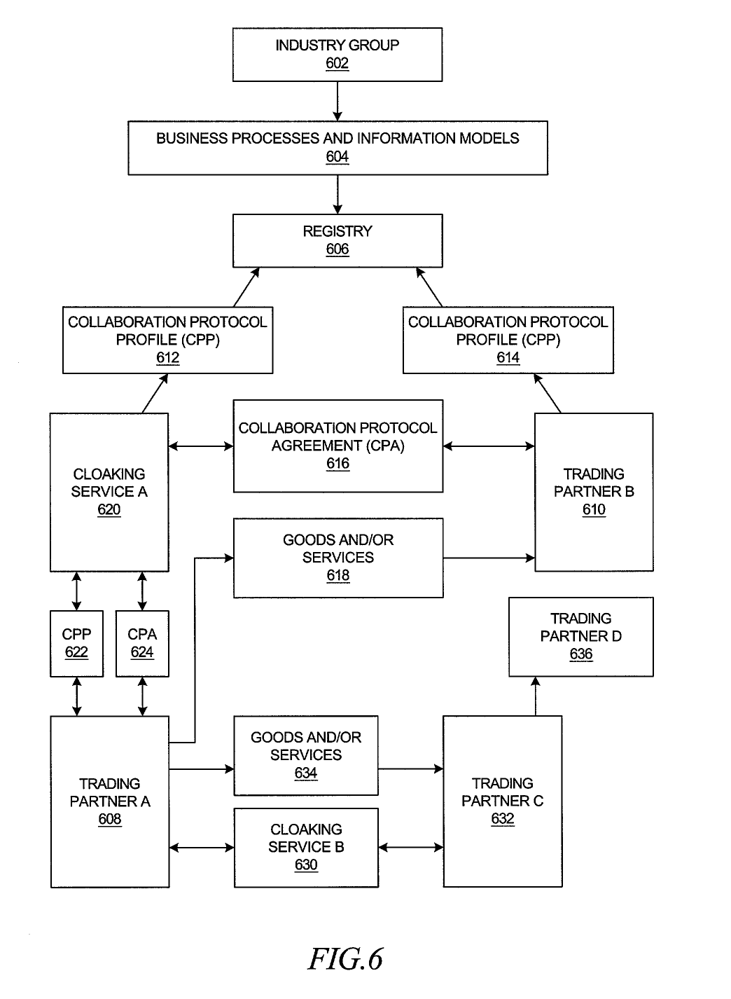

With reference now to FIG. 6, a block diagram depicts a set of commercial entities and data elements for an ebXML electronic business collaboration in addition to a cloaking service in accordance with an implementation of the present invention. FIG. 6 is similar to FIG. 4 in that both diagrams show some of the steps that are involved during a “design time” phase and during a “run time” phase. Industry group 602 defines a set of business processes and information models 604 that are then stored in registry 606 for the benefit of any commercial entity that desires to conduct an electronic business collaboration with another commercial entity using the defined processes and models. Trading partners 608 and 610 represent a pair of commercial entities that use registry 606 in an electronic collaboration. Each trading partner generates a CPP, e.g., CPP 612 or CPP 614, that is stored in registry 606. When these two commercial entities decide to become trading partners, they exchange CPA 616 that defines the terms to which the parties have agreed for a particular collaborative activity. In this example, the trading partners may exchange goods and/or services 618 during their collaborative activity.

In contrast to FIG. 4, cloaking service 620 is employed as an intermediate agent for trading partner 608 rather than trading partner 608 directly communicating with trading partner 610. CPP 622 is similar to CPP 612, but cloaking service 620 modifies and/or deletes some of the information in CPP 622 prior to releasing CPP 612; in addition, CPA 624 is similar to CPA 616, but cloaking service 620 modifies and/or deletes some of the information in CPA 624 prior to releasing CPA 616. In this manner, a cloaking service can be used within an ebXML trading environment while using standardized messaging protocols and standardized structured information.

FIG. 6 also includes an example of trading partner 608 employing a second cloaking service, i.e., cloaking service 630, as an intermediary to trading partner 632. Trading partner 608 exchanges goods and/or services 634 with trading partner 632, which may then resell goods and/or services to trading partner 636, which may be an enterprise that is very similar to trading partner 610 or possibly a competitor to trading partner 610.

In this manner, trading partner 608 is able to cloak its e-commerce activities through cloaking service 630 and is also able to hide its physical commerce activities behind trading partner 632; trading partner 608 could also implement other appropriate confidentiality agreements with trading partner 632. Neither trading partner 610 nor trading partner 636 can gather information about the ebXML activities of trading partner 608. In addition, trading partner 608 has used different cloaking services while performing its collaborative activities with two different trading partners, thereby attaining an extra measure of anonymity if the two different trading partners were to compile and compare information about suppliers for any reason.

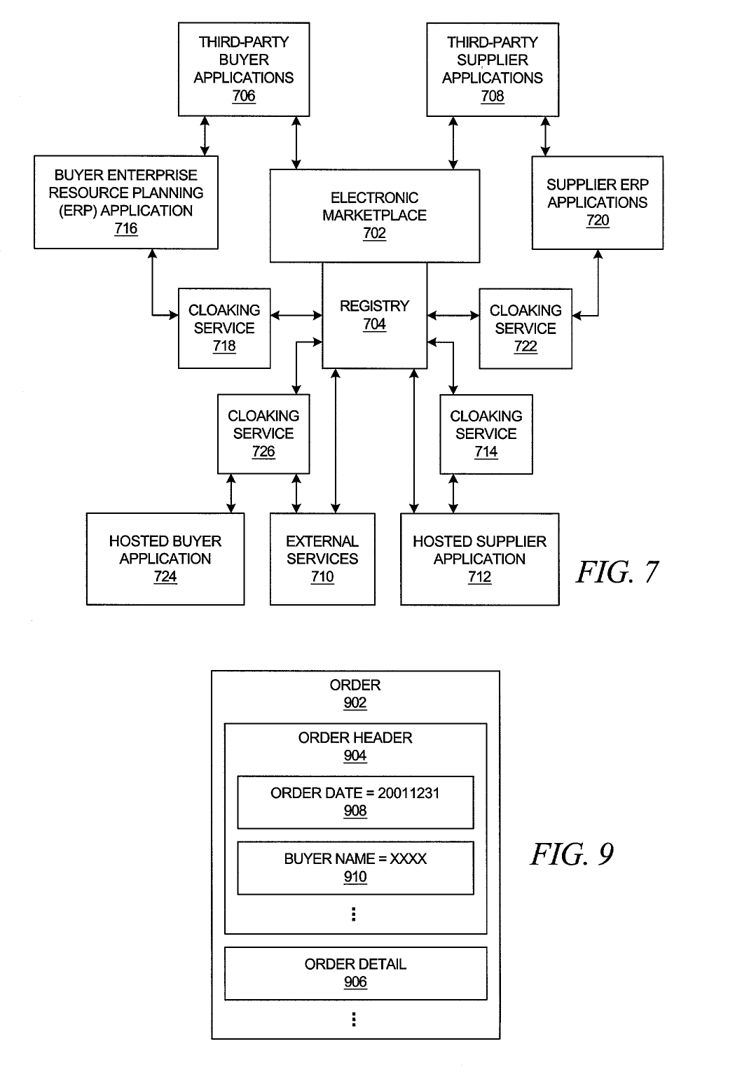

With reference now to FIG. 7, a block diagram depicts a wide variety of software applications that may be used with the cloaking service of the present invention in order to show that the cloaking service is not limited to regarding an enterprise as a monolithic entity. Large commercial enterprises typically have many divisions, each of which may conduct its collaborative business processes in different ways. Different entities within a large commercial enterprise may employ different types of e-commerce software, and each of these different entities may have different reasons for requiring the use of a cloaking service. FIG. 7 illustrates that one or more cloaking services may be employed with these different entities or with these different e-commerce software applications.

Electronic marketplace 702 assists trading partners in conducting e-commerce activities. Electronic marketplace 702 may have an associated registry, e.g., registry 704, with which these trading partners register their available products and services. Although not shown in FIG. 7, one of ordinary skill in the art would understand that multiple registries could be used and that multiple marketplaces may exchange information.

Some implementations of software applications may interact directly through the electronic marketplace via various technologies, such as EDI (Electronic Data Interchange), without the use of an e-commerce registry. For example, third-party buyer application 706 and third-party supplier application 708 may collaborate through electronic marketplace 702 without using registry 704. This example may be relevant to a trading partner that has established customer channels with various third-parties that have not or cannot update its applications for use with registry 704.

In other cases, a trading partner may use software applications that freely exchange information through registry 704. For example, a trading partner may employ external services 710 that perform certain activities that the trading partner is not able to accomplish through its own e-commerce software, yet these external services use registry 704. In another example, a trading partner may have used a third-party for hosting an application, such as hosted supplier application 712, that also interacts directly with registry 704.

For some collaborative activities, such as activities in which the trading partner acts as a supplier towards particular enterprises, the trading partner may use hosted supplier application 712 in conjunction with cloaking service 714 in order to hide some of its activities with these particular enterprises. In other words, rather than directing all collaborative activities from a given software application through a cloaking service, or rather than directing all collaborative activities from a given entity in a large commercial enterprise through a cloaking service, collaborative activities may be cloaked on a selective basis, e.g., depending on volume, shipment dates, or other commercial characteristics. In this manner, a trading partner could provide occasional preferential supply relationships to particular trading partners in a discreet manner.

In the other examples shown in FIG. 7, a trading partner employs a cloaking service with its other e-commerce applications. Buyer ERP (Enterprise Resource Planning) application 716, which may be employed by a third-party, uses cloaking service 718, while supplier ERP application 720, which may also be employed through a third-party, uses cloaking service 722. Hosted buyer application 724 may use cloaking service 726. In this manner, depending upon various conditions, a trading partner may employ several cloaking services at its discretion.

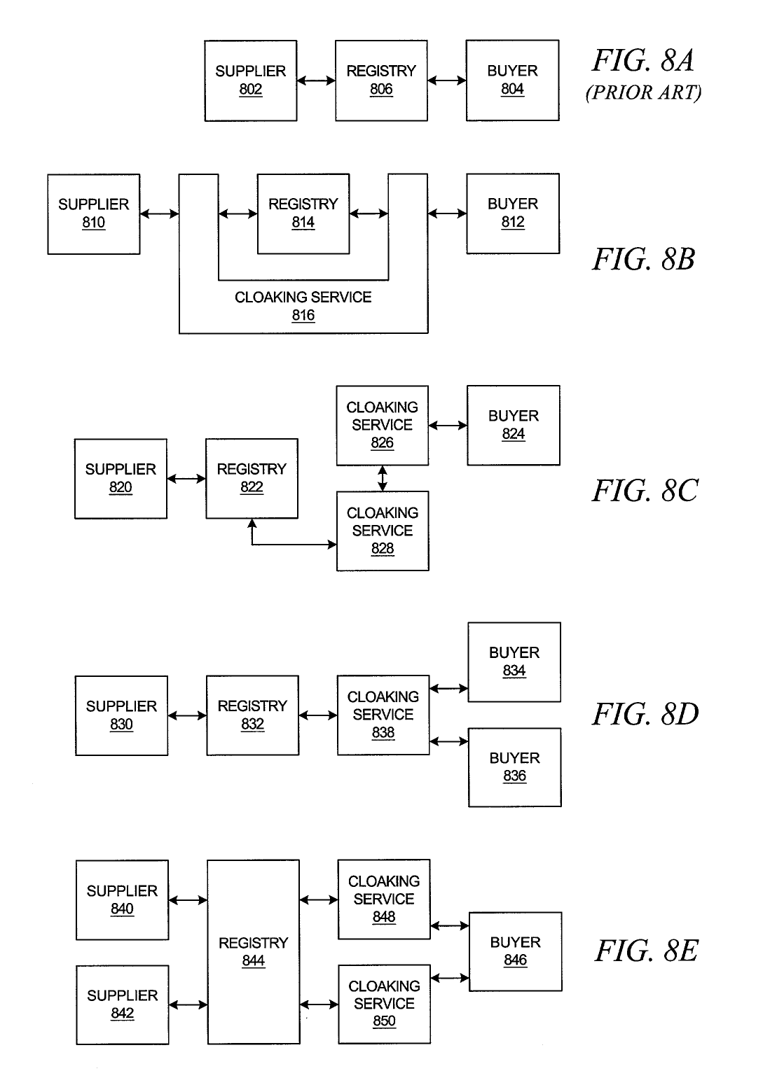

With reference now to FIG. 8A, a block diagram depicts a typical use of an e-commerce marketplace registry. Supplier 802 and buyer 804 coordinate collaborative business processes through registry 806.

With reference now to FIGS. 8B-8E, a set of block diagrams depict generalized data flows between one or more suppliers and one or more buyers in which a cloaking service is used in accordance with the present invention. Whereas FIG. 7 depicts examples in which various applications within a trading partner or controlled by a trading partner may employ a cloaking service conjunction with an electronic marketplace, and whereas FIG. 8A depicts a simple e-commerce arrangement between a buyer and a supplier that use a registry, the examples shown in FIGS. 8A-8E represent a variety of arrangements or organizations of commercial entities in which a cloaking agent may be employed.

Referring to FIG. 8B, supplier 810 and buyer 812 interact with registry 814 indirectly through cloaking service 816. Assuming that the cloaking service adheres to confidentiality policies, the buyer and the supplier are able to use the same cloaking service while maintaining anonymity.

Referring to FIG. 8C, supplier 820 directly interacts with registry 822 while buyer 824 indirectly interacts with registry 822 through a chain of cloaking services including cloaking service 826 and cloaking service 828. As one example of the utility of a cloaking service, this scenario allows a large enterprise to hide all of its activities behind multiple cloaking services, which ensures that the buyer can hide its activities more effectively, i.e., the penetration of one cloaking service does not reveal enough information for a competing entity to determine the identity of the buyer.

Referring to FIG. 8D, supplier 830 directly interacts with registry 832 while buyer 834 and buyer 836 indirectly interact with registry 832 through cloaking service 838. In this scenario, two similar enterprises avoid having a single supplier gain an advantage over either of the buyer entities because the cloaking service hides the collaborative business processes of both buyer entities.

Referring to FIG. 8E, both supplier 840 and supplier 842 directly interact with registry 844, and buyer 846 uses two cloaking services 848 and 850 to indirectly interact with registry 844. In this scenario, a buyer entity can hide price-shopping activities amongst two different supplier entities.

With reference now to FIG. 9, a block diagram depicts an e-commerce message that has been modified by a cloaking service. Order message 902 contains message header 904, which contains metadata associated with order detail 906. The message header contains order date 908 and buyer name 910. However, buyer name 910 has been modified by a cloaking service to delete the identifier that is associated with the buyer entity, thereby effectively hiding the identity of the buyer. A wide variety of other data items could be modified by a cloaking service as requested by an e-commerce entity, such as a billing address, a product name, etc., as long as two e-commerce entity could complete a transaction. Moreover, rather than completely deleting a data item, it could merely be modified in a some manner, such as by masking part of the data item rather than revealing the complete data item or by replacing the data item with substitute information that the cloaking service can relate back to the original information.

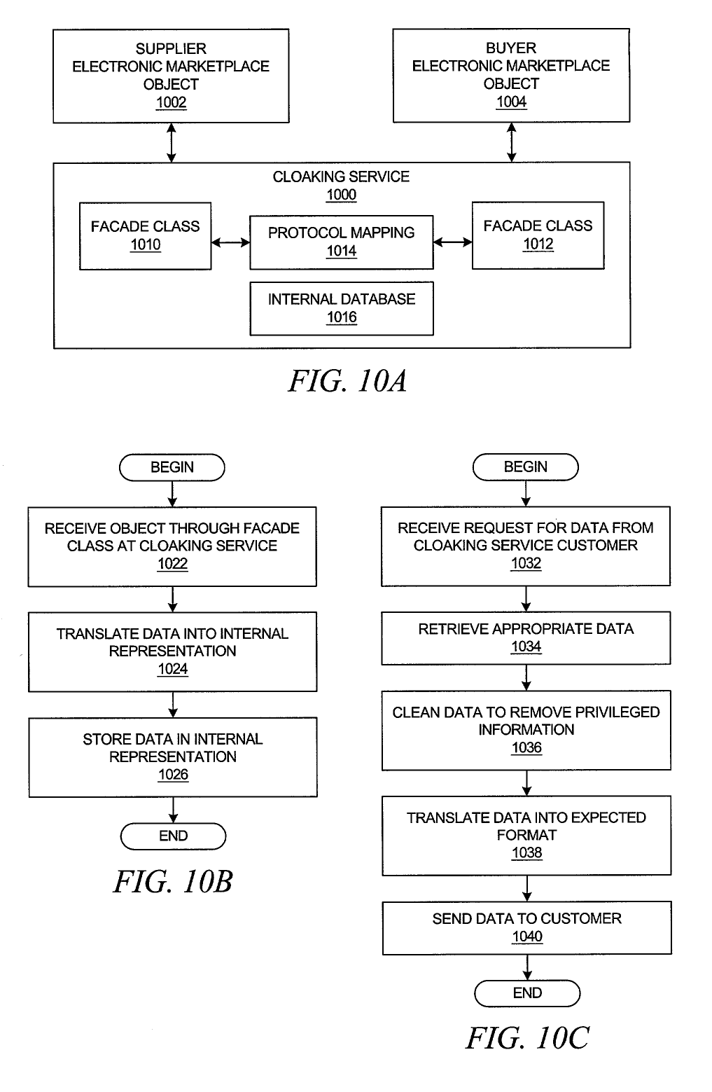

With reference now to FIG. 10A, a block diagram depicts the use of a facade class for passing data objects between a cloaking service and its customer entities, i.e., trading partners that are participating in an electronic marketplace. Cloaking service 1000 accepts and/or generates supplier electronic marketplace object 1002 and buyer electronic marketplace object 1004, e.g., ebXML CPPs. Facade class 1010 may be used to identify and translate data between externally defined protocols and/or neutral representations; facade class 1012 may be different from or identical to facade class 1010. Defined protocol mappings 1014 may be used to assist in translating various data representations. Internal database 1016 is used for storing data as necessary for the customers of cloaking service 1000.

Referring again to FIG. 5, cloaking service 506 acts as an intermediate agent between trading partners 502 and 504 and also between the trading partners and registry 508. FIG. 10A represents an infrastructure by which the cloaking service stores data within various types of internal databases that are necessary for operating with particular e-commerce protocols while also cloaking proprietary data on behalf of its customers.

For example, a customer of a cloaking service may register its CPP within an ebXML-compliant marketplace, but the CPP is initially passed through the cloaking service, which internally stores the entire CPP but registers a cleaned version of the CPP within the ebXML-compliant marketplace's publicly available registries. A customer of the cloaking service could specify a set of preferences with the cloaking service that instructs the cloaking service in the manner in which the cloaking service shall clean various data items from any stored data on behalf of the customer prior to passing the remainder of the data into an electronic marketplace or onto other customers of the cloaking service. These preferences may be considered as being part of the shelling/unshelling unit 524 shown in FIG. 5; the cloaking service could maintain a database of preferences for each of its customers. A customer could modify or remove its preferences over time as necessary when the customer decides to change the information that is revealed to its trading partners, and the cloaking service would reflect the changed preferences in the manner in which it cloaks data on behalf of the customer.

With reference now to FIG. 10B, a flowchart depicts a process of accepting data at a cloaking service. The cloaking service receives an e-commerce data object, e.g., an ebXML CPP, through a facade class (step 1022), and the received data is then translated into an internal representation (step 1024) and stored for subsequent retrieval when necessary (step 1026).

With reference now to FIG. 10C, a flowchart depicts a process of providing e-commerce information from a cloaking service. A data request is received at the cloaking service (step 1032), such as a request for the CPP of a particular e-commerce trading partner. The appropriate data is retrieved from the internal database of the cloaking service (step 1034), and the cloaking service removes privileged information from the retrieved data (step 1036). If necessary, the data is also translated into a data format that is expected by the receiving customer (step 1038), and the data is then sent to the customer (step 1040), thereby completing the process.

For example, the cloaking service can be used in the following manner. With respect to an electronic marketplace that is using the ebXML set of specifications and standards, the cloaking service can maintain a CPP for a first customer in an ebXML registry. When a second customer requests to retrieve the CPP of the first customer, the cloaking service cleans the CPP of certain data items prior to sending a copy of the CPP to the second customer, as illustrated in FIG. 9. In this manner, the first customer can register a large amount of information with the cloaking service and then direct the cloaking service to provide only subsets of the registered data to other entities that request the information. The cloaking service understands multiple different protocols for servicing its customers and for interacting with different electronic marketplaces that use these different protocols, and the cloaking service uses its knowledge of the different protocols to translate the subsets of registered data into the e-commerce protocol that is required and/or expected by the requesting customer.

The advantages of the present invention should be apparent in view of the detailed description of the invention that has been provided above. The widespread adoption of standardized protocols for electronic marketplaces has allowed business entities to interface with electronic exchanges with reduced costs and complexity. However, there has remained a need for business entities to maintain some level of control or confidentiality in their proprietary data. The present invention provides a set of techniques whereby a business entity may maintain confidentiality of its proprietary data while enabling the business entity to interface with one or more electronic marketplaces that require a certain level of openness in e-commerce transactions.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing data for electronic business transactions, the method comprising:
receiving a document for an electronic business transaction from a first entity in an electronic marketplace;
retrieving a set of cloaking preferences for the first entity;
modifying the document in accordance with the set of cloaking preferences; and
forwarding the modified document to a second entity in an electronic marketplace.

2. The method of claim 1 further comprising:
registering a set of cloaking preferences from the first entity.

3. The method of claim 1 further comprising:
scanning the document for data elements that are specified in the set of cloaking preferences; and
altering at least one data element in accordance with the set of cloaking preferences if the set of cloaking preferences has an indication that a data element should be modified.

4. The method of claim 3 wherein the step of altering the data element comprises nullifying the data element.

5. The method of claim 3 wherein the step of altering the data element comprises:
retrieving a data element; and
storing the retrieved data element in association with information for the document and the first entity such that the data element may be subsequently returned to the first entity or reassociated with a copy of document.

6. The method of claim 1 wherein the document is formatted in accordance with an ebXML (electronic business extensible Markup Language) specification.

7. The method of claim 1 further comprising:
changing a format of the document from a first protocol to a second protocol prior to forwarding the document.

8. A method for processing data for electronic business transactions, the method comprising:
generating a first document for an electronic business transaction by a first entity in an electronic marketplace; and
sending the first document through a cloaking service to a second entity in the electronic marketplace.

9. The method of claim 8 further comprising:
registering a set of cloaking preferences with the cloaking service by the first entity.

10. The method of claim 8 further comprising:
receiving a second document at the first entity in the electronic marketplace through a cloaking service from the second entity in the electronic marketplace.

11. The method of claim 8 further comprising:
committing to the electronic business transaction by the first entity in the electronic marketplace.

12. The method of claim 8 further comprising:
performing commercial operations for the electronic business transaction by the first entity in the electronic marketplace.

13. An apparatus for processing data for electronic business transactions, the apparatus comprising:
means for receiving a document for an electronic business transaction from a first entity in an electronic marketplace;
means for retrieving a set of cloaking preferences for the first entity;
means for modifying the document in accordance with the set of cloaking preferences; and
means for forwarding the modified document to a second entity in an electronic marketplace.

14. The apparatus of claim 13 further comprising:
means for registering a set of cloaking preferences from the first entity.

15. The apparatus of claim 13 further comprising:
means for scanning the document for data elements that are specified in the set of cloaking preferences; and
means for altering at least one data element in accordance with the set of cloaking preferences if the set of cloaking preferences has an indication that a data element should be modified.

16. The apparatus of claim 15 wherein the means for altering the data element comprises nullifying the data element.

17. The apparatus of claim 15 wherein the means for altering the data element comprises:
means for retrieving a data element; and
means for storing the retrieved data element in association with information for the document and the first entity such that the data element may be subsequently returned to the first entity or reassociated with a copy of document.

18. The apparatus of claim 13 wherein the document is formatted in accordance with an ebXML (electronic business extensible Markup Language) specification.

19. The apparatus of claim 13 further comprising:
means for changing a format of the document from a first protocol to a second protocol prior to forwarding the document.

20. An apparatus for processing data for electronic business transactions, the apparatus comprising:
means for generating a first document for an electronic business transaction by a first entity in an electronic marketplace; and
means for sending the first document through a cloaking service to a second entity in the electronic marketplace.

21. The apparatus of claim 20 further comprising:
means for registering a set of cloaking preferences with the cloaking service by the first entity.

22. The apparatus of claim 20 further comprising:
means for receiving a second document at the first entity in the electronic marketplace through a cloaking service from the second entity in the electronic marketplace.

23. The apparatus of claim 20 further comprising:
means for committing to the electronic business transaction by the first entity in the electronic marketplace.

24. The apparatus of claim 20 further comprising:
means for performing commercial operations for the electronic business transaction by the first entity in the electronic marketplace.

25. A computer program product in a computer readable medium for use in a data processing system for processing data for electronic business transactions, the computer program product comprising:
instructions for receiving a document for an electronic business transaction from a first entity in an electronic marketplace;
instructions for retrieving a set of cloaking preferences for the first entity;
instructions for modifying the document in accordance with the set of cloaking preferences; and
instructions for forwarding the modified document to a second entity in an electronic marketplace.

26. The computer program product of claim 25 further comprising:
instructions for registering a set of cloaking preferences from the first entity.

27. The computer program product of claim 25 further comprising:
instructions for scanning the document for data elements that are specified in the set of cloaking preferences; and
instructions for altering at least one data element in accordance with the set of cloaking preferences if the set of cloaking preferences has an indication that a data element should be modified.

28. The computer program product of claim 27 wherein the instructions for altering the data element comprises nullifying the data element.

29. The computer program product of claim 27 wherein the instructions for altering the data element comprises:
instructions for retrieving a data element; and
instructions for storing the retrieved data element in association with information for the document and the first entity such that the data element may be subsequently returned to the first entity or reassociated with a copy of document.

30. The computer program product of claim 25 wherein the document is formatted in accordance with an ebXML (electronic business extensible Markup Language) specification.

31. The computer program product of claim 25 further comprising:
instructions for changing a format of the document from a first protocol to a second protocol prior to forwarding the document.

32. An computer program product for processing data for electronic business transactions, the computer program product comprising:
instructions for generating a first document for an electronic business transaction by a first entity in an electronic marketplace; and
instructions for sending the first document through a cloaking service to a second entity in the electronic marketplace.

33. The computer program product of claim 32 further comprising:
instructions for registering a set of cloaking preferences with the cloaking service by the first entity.

34. The computer program product of claim 32 further comprising:
means for receiving a second document at the first entity in the electronic marketplace through a cloaking service from the second entity in the electronic marketplace.

35. The computer program product of claim 32 further comprising:
means for committing to the electronic business transaction by the first entity in the electronic marketplace.

36. The computer program product of claim 32 further comprising:
means for performing commercial operations for the electronic business transaction by the first entity in the electronic marketplace.
